(19) United States
(12) Patent Application Publication
(10) Pub. No.: US 2005/0005101 A1
(43) Pub. Date: Jan. 6, 2005

(54) Kernel cryptographic module signature verification system and method

(76) Inventor: Bhargava K. Yenduri, Santa Clara, CA (US)

Correspondence Address: MARTINE & PENILLA, LLP, 710 LAKEWAY DRIVE, SUITE 170, SUNNYVALE, CA, 94085, US

(21) Appl. No.: 10/613,636

(22) Filed: Jul. 3, 2003

(51) Int. Cl. H04L 9/00; G06F 12/14

(52) U.S. Cl. 713/164; 713/187

(57) ABSTRACT

A computer operating system having a kernel with a kernel module signature verification unit is described herein. The kernel module signature verification unit automatically monitors kernel module signature path and extracts the signature information provided by each module attempting to load to the kernel. The signature information captured from the kernel module path is retrieved by a kernel cryptographic framework to verify the signature information provided by a kernel cryptographic framework daemon when the same kernel module attempts to register its routines and mechanisms with the kernel cryptographic framework.

### FIELD OF THE INVENTION

The present claimed invention relates generally to the field of computer operating systems. More particularly, embodiments of the present claimed invention relate to a system for verifying kernel module signature data.

### BACKGROUND ART

A computer system can be generally divided into four components: the hardware, the operating system, the application programs and the users. The hardware (e.g., central processing unit (CPU), memory and input/output (I/O) devices) provides the basic computing resources. The application programs (e.g., database systems, games, business programs (database systems, etc.) define the ways in which these resources are used to solve computing problems. The operating system controls and coordinates the use of the hardware resources among the various application programs for the various users. In doing so, one goal of the operating system is to make the computer system convenient to use. A secondary goal is to use the hardware in an efficient manner.

The Unix operating system is one example of an operating system that is currently used by many enterprise computer systems. Unix was designed to be a time-sharing system, with a hierarchical file system, which supported multiple processes. A process is the execution of a program and consists of a pattern of bytes that the CPU interprets as machine instructions (text), data and stack. A stack defines a set of hardware registers or a reserved amount of main memory that is used for arithmetic calculations.

The Unix operating system consists of two separable parts: the “kernel” and the “system programs.” Systems programs consist of system libraries, compilers, interpreters, shells and other such programs that provide useful functions to the user. The kernel is the central controlling program that provides basic system facilities. The Unix kernel creates and manages processes, provides functions to access file-systems, and supplies communications facilities.

The Unix kernel is the only part of Unix that a user cannot replace. The kernel also provides the file system, CPU scheduling, memory management and other operating-system functions by responding to “system-calls.” Conceptually, the kernel is situated between the hardware and the users. System calls are used by the programmer to communicate with the kernel to extract computer resource information. The robustness of the Unix kernel allows system hardware and software to be dynamically configured to the operating system while applications programs are actively functional without having to shut-down the underlying computer system.

Thus, when system hardware or software resource changes are implemented in a computer system having the Unix operating system, the kernel is typically configured or reconfigured to recognize the changes. These changes are then made available to user applications in the computer system. Furthermore, as system errors and faults occur in the underlying operating system, the kernel is able to identify these errors and faults and make them available to applications that these error and faults may affect. Applications typically make system calls by way of “system traps” to specific locations in the computer hardware (sometimes called an “interrupt” location or vector) to collect information on these system errors. Specific parameters are passed to the kernel on the stack and the kernel returns with a code in specific registers indicating whether the action required by the system call was successfully completed or not.

FIG. 1 is a block diagram illustration of an exemplary prior art computer system 100. The computer system 100 is connected to an external storage device 180 and to an external drive device 120 through which computer programs can be loaded into computer system 100. The external storage device 180 and external drive 120 are connected to the computer system 100 through respective bus lines. The computer system 100 further includes main memory 130 and processor 110. The drive 120 can be a computer program product reader such a floppy disk drive, an optical scanner, a CD-ROM device, etc.

FIG. 1 additionally shows memory 130 including a kernel level memory 140. Memory 130 can be virtual memory which is mapped onto physical memory including RAM or a hard drive, for example. The robustness of the Unix operating system and the dynamic ability to reconfigure the Unix kernel also makes the kernel susceptible to unauthorized access and intrusive attacks.

There is currently cryptographic software that only operate in the application space of the operating system of the personal computer. Therefore, it can only be called upon by an application, such E-mail, Microsoft Word or the like. In this prior art system, the cryptographic software cannot work in the kernel space of the operating system. The kernel space is that layer of operating system which is essentially non-visible to the user at the driver level of the computer system, for example, where IP packets are processed, where a disc drive controller software resides, where the computer system's printer drivers are located, etc.

In this prior art embodiment, kernel space routines cannot cross the line into application space. Therefore, if one wants to encrypt data or instructions coming in or out of the hard drive, the cryptographic software would not be usable, as it resides in the application space and not in the kernel space. Similarly, the IP packets would also be unable to be encrypted using cryptographic software as the IP packets are processed in the kernel space.

To enable cryptographic software operations in the kernel space, some prior art systems as illustrated in FIG. 2 provide cryptographic software implementation wherein the software is situated in each application space and in devices that access the kernel space of a standard operating system. The separate application space and device space software are then linked together to exchange cryptographic functions, such as algorithms, digital signatures, hash functions, etc.

In the this prior art solution, each application space and device space cryptographic software includes a generic layer with a program interface and a cryptographic service module having a library of encryption algorithms which electronically communicate with the program interface. However, this prior art solution does not have a standard authentication and security approach to prevent unauthorized and unwanted applications and devices from intruding he kernel. This prior art solution is also cumbersome and costly since each device wishing to access the kernel's cryptographic service needs a copy of the cryptographic software loaded in it. The prior art solution further does not offers any reliable way of ensuring that only verified devices or device drivers are accessing the kernel since non-validated kernel modules are able to by-pass the kernel's encryption scheme to write code to the kernel driver layer

Furthermore, the kernel verification methods by current prior art techniques require massive amounts of redundant data which unnecessarily consume system resources, particularly memory. The unnecessary consumption of system resources by the large volume of prior art kernel verification processes also results in performance degradation to the underlying computer system.

### SUMMARY OF INVENTION

Accordingly, to take advantage of the many security application programs available and the increasing number of new applications being developed to handle the associated security issues, a system is needed that allows a programmer to add extensions to a kernel to automatically verify kernel module additions to the kernel of kernel cryptographic modules without disrupting the functionality of the kernel for other operations. Further, a need exists to automatically generate kernel module verification data without having to unduly burden system resources in the underlying computer system. A need further exists for an improved and less costly program independent operating system, which improves efficiency, reliability and provides a means to implement kernel level cryptographic verification without losing the embedded features designed in the kernel.

What is described herein is a computer system having a kernel structure that provides a technique for automatically providing secure method for conveying the results of signature based kernel module verification from the loading of loadable kernel modules, and ensuring the binding between the signature and the image of the module being loaded. Embodiments of the present invention allow programmers to automatically verify and authenticate kernel modules attempting to load into the kernel to become cryptographic service providers without having to use up substantial portions of kernel memory. Embodiments of the present invention allow kernel modules to be loaded into a kernel using a signature verification scheme that minimizes the potential of unauthorized modules from being loaded into the kernel.

The kernel module authentication system provides loadable kernel modules with an authenticating means of authenticating and verifying kernel modules prior to these modules being loaded into the kernel.

Embodiments of the present invention include kernel cryptographic framework daemon that helps in managing signature information validation between the kernel cryptographic framework and external storage device in the underlying computer system. The kernel cryptographic framework daemon also does module verification for kernel cryptographic modules.

Embodiments of the present invention also include kernel cryptographic framework that enables authenticated and verified kernel cryptographic modules to be loaded into the kernel as cryptographic service providers. The kernel cryptographic framework communicates with the kernel cryptographic daemon using input/output control commands to initiate the authentication and verification scheme of the present invention.

Embodiments of the present invention further include kernel cryptographic verification logic for verifying the kernel module signatures to ensure that files whose signatures are verified are the one being loaded and installed in the kernel. The verification module includes logic to store the signature information and signature length of each file in order to enable the verification of signature information of each file.

Embodiments of the kernel cryptographic framework of the present invention include registration logic that allows each kernel cryptographic module to register with the kernel cryptographic framework for verification and authentication. The registration logic enables the kernel cryptographic framework to compare signature information presented by a particular kernel module with the signature information retrieved by the kernel cryptographic framework daemon in order to determine the security of the signature presented.

Embodiments of the kernel cryptographic framework of the present invention include a framework communication routine that allows the kernel cryptographic framework to communicate with the kernel cryptographic framework daemon. The kernel cryptographic framework and daemon interact using input/output control commands. The daemon calls these commands during an initial communication routine of the kernel cryptographic framework verification scheme and during the operation of the kernel cryptographic framework verification process of the present invention.

These and other objects and advantages of the present invention will no doubt become obvious to those of ordinary skill in the art after having read the following detailed description of the preferred embodiments which are illustrated in the various drawing figures.

### BRIEF DESCRIPTION OF THE DRAWINGS

The accompanying drawings, which are incorporated in and form a part of this specification, illustrate embodiments of the invention and, together with the description, serve to explain the principles of the invention:

FIG. 1 is a block diagram of a prior art computer system;

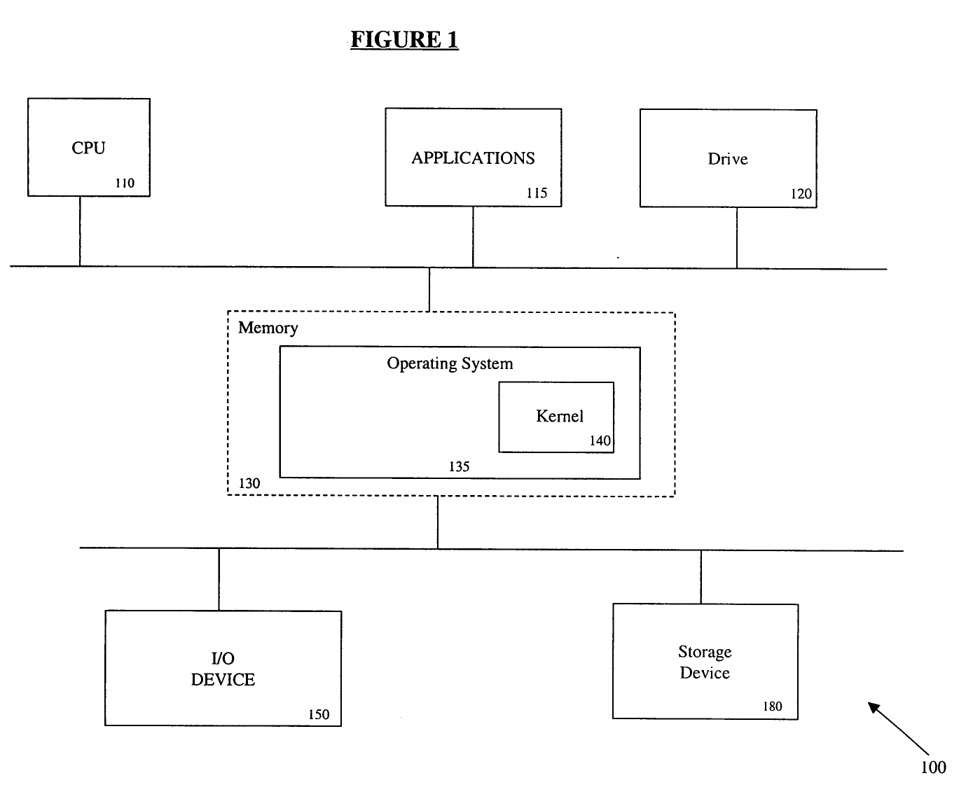

FIG. 2 is a block diagram of a prior art kernel cryptographic verification method of a prior art computer system;

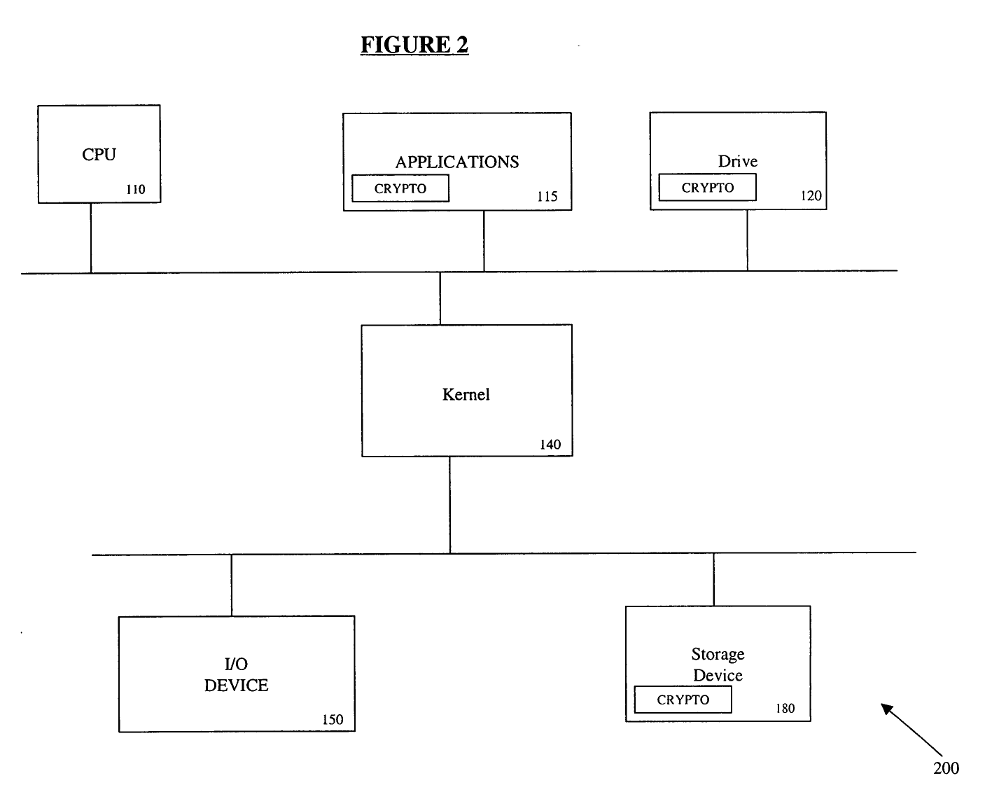

FIG. 3 is a block diagram of an embodiment of a computer system in accordance with the present invention;

FIG. 4 is a block diagram of one embodiment of the kernel module verification system of one embodiment of the kernel data formatting system of the present invention;

FIG. 5 is a block diagram of one embodiment of an internal architecture of one embodiment of the kernel cryptographic framework of one embodiment of the present invention; and

FIG. 6 is a flow diagram of one embodiment of an exemplary module verification interaction of the present invention.

### DESCRIPTION OF THE PREFERRED EMBODIMENTS

Reference will now be made in detail to the preferred embodiments of the invention, examples of which are illustrated in the accompanying drawings. While the invention will be described in conjunction with the preferred embodiments, it will be understood that they are not intended to limit the invention to these embodiments.

On the contrary, the invention is intended to cover alternatives, modifications and equivalents, which may be included within the spirit and scope of the invention as defined by the appended Claims. Furthermore, in the following detailed description of the present invention, numerous specific details are set forth in order to provide a thorough understanding of the present invention. However, it will be obvious to one of ordinary skill in the art that the present invention may be practiced without these specific details. In other instances, well-known methods, procedures, components, and circuits have not been described in detail as not to unnecessarily obscure aspects of the present invention.

The embodiments of the invention are directed to a system, an architecture, subsystem and method to automatically verify and authenticate kernel cryptographic modules in an underlying kernel space in a computer system. In accordance with an aspect of the invention, a kernel module signature information is processed and verified to protect the security of the computer system from unauthorized system intruders to the underlying operating system and the other applications running in the computer system.

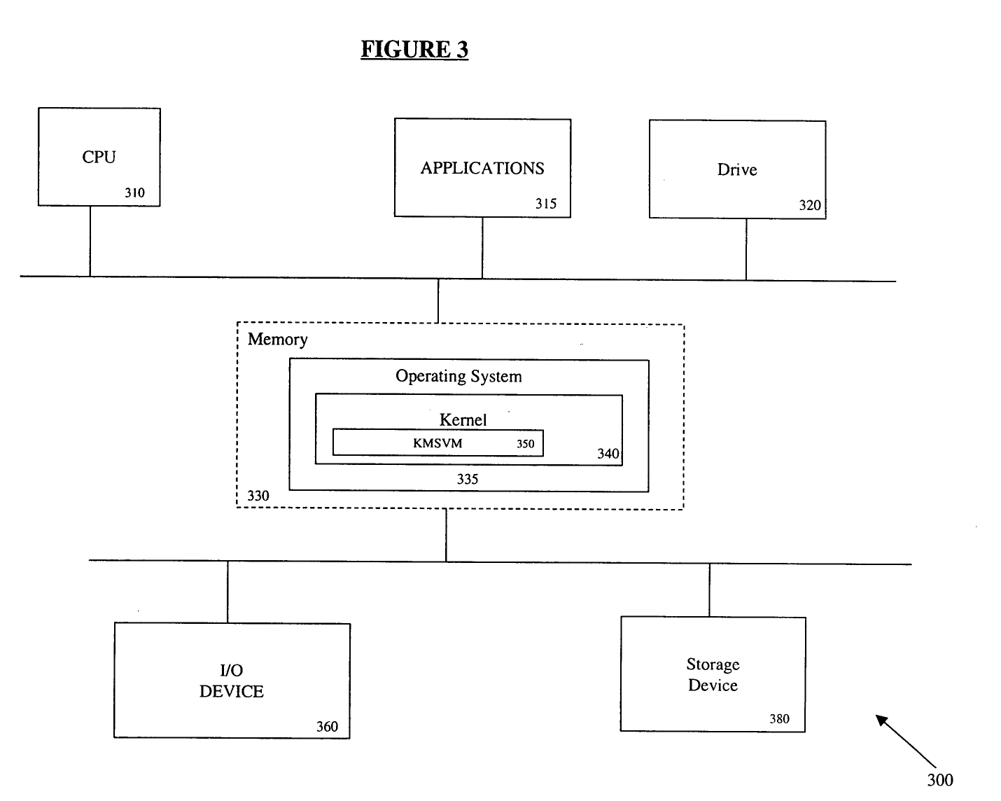

FIG. 3 is a block diagram illustration of one embodiment of a computer system 300 of the present invention. The computer system 300 according to the present invention is connected to an external storage device 380 and to an external drive device 320 through which computer programs according to the present invention can be loaded into computer system 200. External storage device 380 and external drive 320 are connected to the computer system 200 through respective bus lines. Computer system 300 further includes main memory 330 and processor 310. Drive 320 can be a computer program product reader such a floppy disk drive, an optical scanner, a CD-ROM device, etc.

FIG. 3 shows memory 330 including a kernel level memory 340. Memory 330 can be virtual memory which is mapped onto physical memory including RAM or a hard drive, for example, without limitation. During process execution, a programmer programs data structures in the memory at the kernel level memory 340.

According an embodiment of the present invention, the kernel memory level 340 includes a kernel module signature verification system (KMSVM) 350. The KMSVM 350 comprises kernel cryptographic framework (KCF) and a kernel cryptographic framework daemon (KCFD) for processing kernel cryptographic module signatures to authenticate and verify the kernel modules ability to be loaded into the kernel memory 340.

The KMSVM 350 automatically monitors kernel module path and extracts the signature information provided by each module attempting to load to the kernel 340. The signature information retrieved for the kernel module path is provided by the kernel cryptographic framework daemon to verify the signature information provided by the kernel cryptographic framework when the same kernel module attempts to register the signature information with the kernel cryptographic framework.

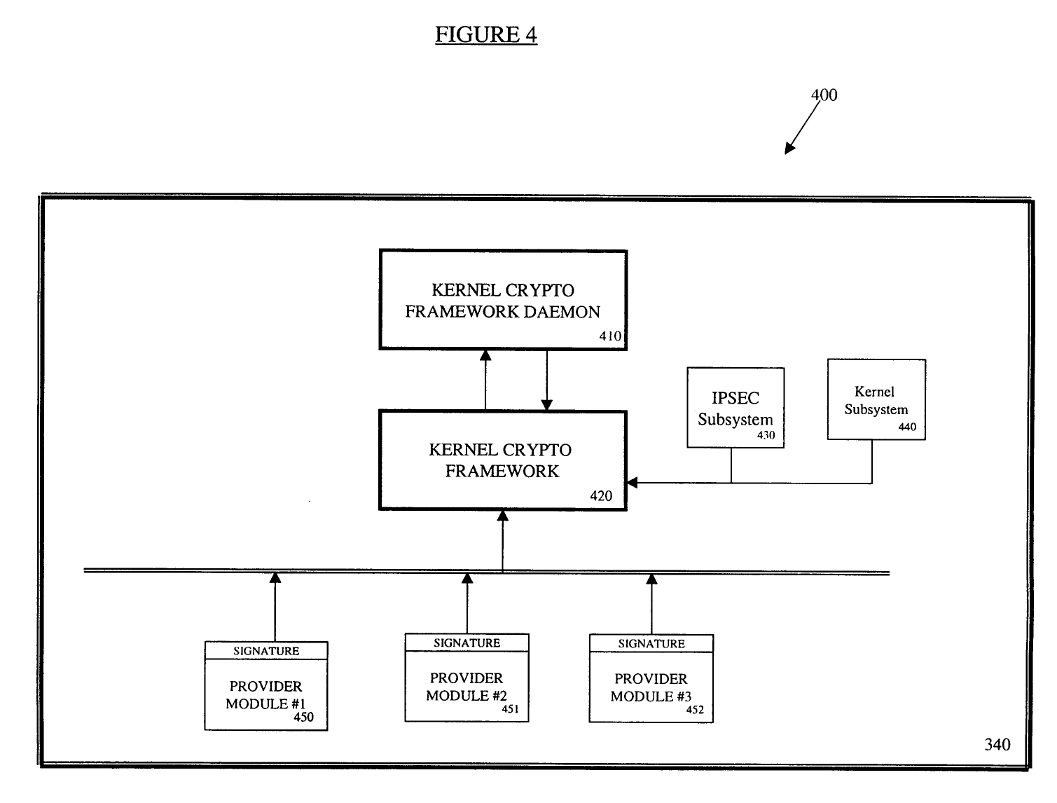

FIG. 4 is a block diagram illustrating an implementation of one embodiment of the KMSVM 350 of the present invention. The KMSVM 350 comprises kernel cryptographic framework daemon 400, kernel cryptographic framework 410, kernel subsystems 420-430, kernel cryptographic modules 440-460 and kernel cryptographic module signatures 441-461.

The kernel cryptographic framework daemon (KCFD) 400 is a daemon which helps in retrieving signature verification information from a storage device in the computer system every time a cryptographic module attempts to request to be loaded into the kernel 340. In one embodiment of the present invention, the KCFD 400 does module verification for kernel cryptographic modules 440-460 using information extracted from the file path names of the modules 440-460. In one embodiment of the present invention, the KCFD 400 interacts with the kernel cryptographic framework (KCF) 410 using input/output control commands.

In one embodiment of the present invention, when a cryptographic module requests to be loaded into the kernel 340, the module path information presented by the module to the KCF 410 is passed on to the KCFD 400 which retrieves a corresponding signature information from system storage. The KCFD 400 responses to the verification request by providing the KCF 410 signature status information, signature length information and signature size information. An exemplary signature verification communication code between the KCFD 400 and the KCF 410 is as follows:

#ifdef_cplusplus
extern “C” {
#endif
typedef enum ELFsign_status_e {

ELFSIGN_UNKNOWN,
ELFSIGN_SUCCESS,
ELFSIGN_FAILED,
ELFSIGN_NOTSIGNED

} ELFsign_status_t;
#define KCF_KCFD_VERSION 1 1
#define SIG_MAX_LENGTH 1024
typedef struct kcf_door_arg_s {

short da_version;
union {

| | |
|---|---|
| char filename [MAXPATHLEN]; | /*For request */ |
| struct kcf_door_results_s { | /*For response*/ |

| | |
|---|---|
| ELFsign_status_t | status; |
| unit32_t | siglen; |

uchar_t signature [SIG_MAX_LENGTH];

} result;

} da_u

} kcf_door_arg_t;
#ifdef_cplusplus
}
#endif

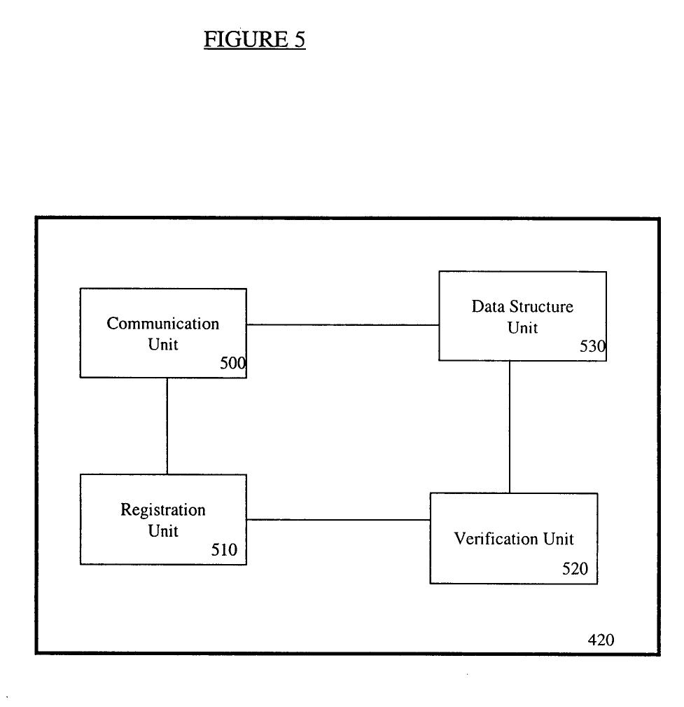

Reference is now made to FIG. 5 which is a block diagram illustration of one embodiment of an internal architecture of the KCF 410 of the present invention. As depicted in FIG. 4, the KCF 410 comprises communication module 500, registration module 510, verification module 520 and data structure module 530.

The communication module 500 enables the KCF 410 to communicate with the KCFD 400. In one embodiment of the present invention, the KCF 410 and the KCFD 400 communicate using input/output control commands that allows the KCF 410 to generate doors that are created by the KCFD 400 during system boot time and a door ID is passed to the kernel 340. Since there isn't a door file, it is difficult for an intruder to snoop on communications between the KCFD 400 and the KCF 410. In one embodiment of the present invention, the communication module 500 is implemented as system calls that the KCF 410 may make to the kernel to pass data to and from the KCFD 400.

The registration module 510 enables the KCF 410 handle load registration requests by cryptographic modules wishing to join the kernel as cryptographic service providers in the kernel space. In one embodiment of the present invention, when cryptographic modules register, they have to be authenticated prior to being added to the list of service providers by the KCF 410.

As part of the registration process the KCF 410 keeps the signature information and signature length data for each requesting cryptographic module in its internal data structure 530. The information retained in data structure 530 is compared with signature information received from the KCFD 400 in response to KCF 410 requests.

Each signature information provided by a requesting cryptographic module is verified by the verification module 520 in order to determine whether the requesting module is a legitimate module that must be loaded by the KCF 410. In one embodiment of the present invention, signature information provided by each requesting cryptographic module is the result of compiling, among other cryptographic measures, an internal private security key and a public security key. In one embodiment of the present invention, additional precautionary security measures may be adopted to ensure that only those modules authenticated and verified are allowed to be loaded to the list of service providers. In one embodiment of the present invention, the structure module 530 may be extended to add additional fields to further restrict the ability of intruding modules to be loaded by the KCF 410.

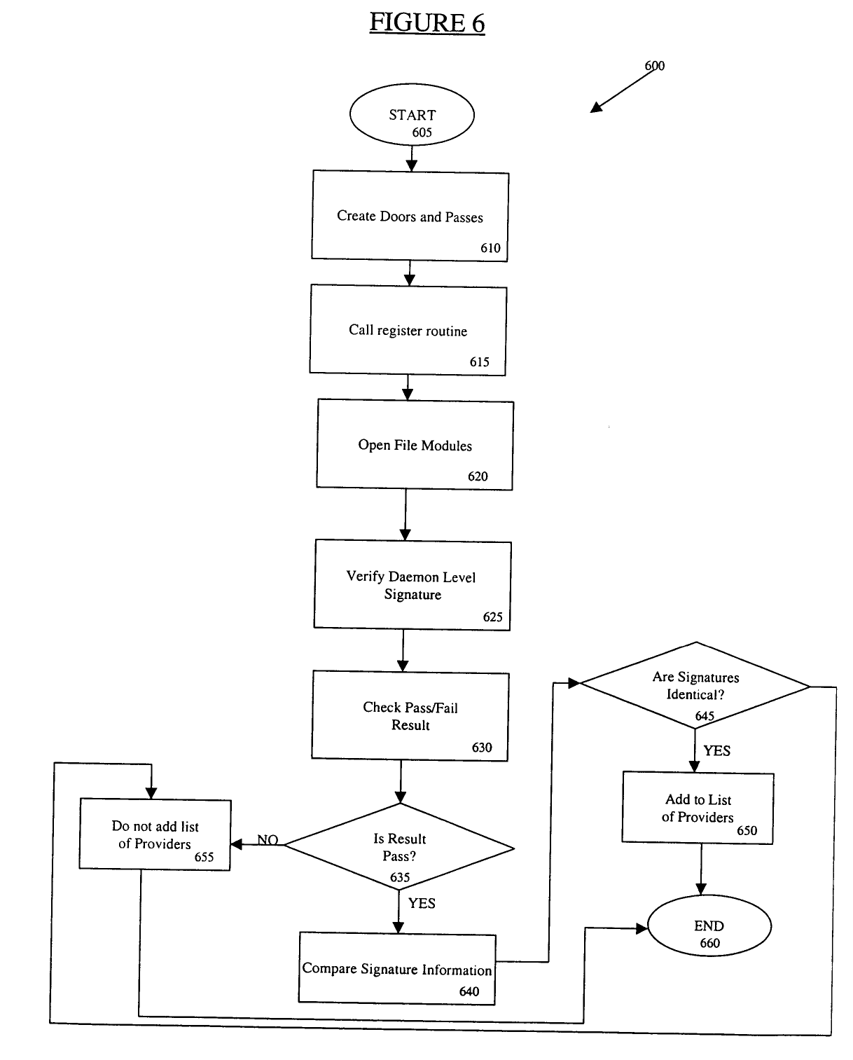

FIG. 6 is a computer implemented software of a block diagram illustration of an exemplary computer software implemented interaction pattern 600 of one embodiment of the present invention. As shown in FIG. 6, the cryptographic module signature verification process begins at step 605. And at step 610, during system boot time, the KCFD 400 creates an unnamed door and passes the door identification to the KCF 410 by an ioctl command (e.g., (fd, CRYPTO_LOAD_DOOR,..)). This door is used for communication between the KCFD 400 and the KCF 410. Since there is no door file, it is difficult for an intruder to snoop on this communication.

At step 615, a cryptographic module is loaded and calls the register routine to register with the KCF 410 as a cryptographic provider. In one embodiment of the present invention, the cryptographic module includes a signature section, which is provided to the KCF 410 during the module load. The KCF 410 needs to verify the module before adding it to its list of providers. The KCF 410 does this by making a door upcall and passing the full pathname of the module to the KCFD 400. In one embodiment of the present invention, the register routine is called from an initialization routine for a software provider or from a hardware routine of the hardware provider.

At step 620, the KCFD 400 opens the file/module and calls a verification routine (e.g., (fverify_elf_signature(int fd)) and a get signature routine (e.g., get_elf_signature(char *pathname, char *signature, int *sig_len).

At step 625, the KCFD 400 passes of the result of the signature verification of the cryptographic module back to the kCF 410. This result has three components: PASS/FAIL result from the verification; the signature information and the signature length. The signature information and the signature length are also passed to the KCF 410 to address an intrusion scenario.

At step 630, the KCF 410 checks the PASS/FAIL result from the KCFD 400 verification of the module signature. And at step 635, if the signature verification result is a “PASS”, the signature information and the signature length are compared with corresponding fields in the module structure at step 640.

At step 645, if the signature information and signature length provided by the KCFD 400 are identical to the fields in the module structure, the module is determined to have passed verification and is added to the KCF 410 list of cryptographic providers at step 650.

At step 655, if the signature information and signature length do not compare with the corresponding fields in the module structure or if the signature verification is a failure from the KCFD 400, the KCF 410 logs a system log warning message and returns from the module registration routine and the cryptographic module is not added to the list of cryptographic providers by the KCF 410.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications are suited to the particular use contemplated. It is intended that the scope of the invention be defined by the Claims appended hereto and their equivalents.

1. A computer system comprising:
a processor;
a memory storage unit;
an operating system comprising a kernel, said kernel comprising a plurality of kernel modules, said kernel modules comprising signature information; and
a kernel module signature verification system for verifying said kernel module signature information of each of said plurality of kernel modules as said plurality of kernel modules are loaded into said kernel.

2. The computer system of claim 1, wherein said kernel module signature information is generated via a public key and a private key compilation in said kernel module.

3. The computer system of claim 2, wherein said kernel module signature information comprises signature length data unique to each of said plurality of kernel modules, said signature length data used by said kernel module signature verification system in uniquely identifying each of said plurality of kernel modules.

4. The computer system of claim 3, wherein said kernel module signature information further comprises signature size data for further uniquely identifying each of said kernel module.

5. The computer system of claim 4, wherein said kernel module signature verification system comprises a kernel cryptographic framework for verifying said kernel module signature information.

6. The computer system of claim 5, wherein said kernel module signature verification system further comprises a kernel cryptographic framework daemon for performing verification lookup operations of signature information provided to said kernel cryptographic framework in said kernel.

7. The computer system of claim 6, wherein said kernel cryptographic framework daemon further performs module verification of said plurality of kernel modules.

8. The computer system of claim 7, wherein said kernel cryptographic framework retrieves pathname information of said signature information for each of said plurality of kernel modules when said plurality of kernel modules attempt to load up to said kernel to perform cryptographic operations.

9. The computer system of claim 8, wherein said kernel cryptographic framework comprises a cryptographic service provider registration unit for registering each of said plurality of kernel modules wishing to provide cryptographic services in said kernel.

10. The computer system of claim 9, wherein said kernel cryptographic framework further comprises a intra-kernel communication unit for enabling communications between said kernel cryptographic framework and said kernel cryptographic framework daemon.

11. The computer system of claim 10, wherein said kernel cryptographic framework further comprises a data structure unit for storing said kernel module signature information.

12. A computer operating system comprising:
a memory storage unit;
a kernel, said kernel comprising a plurality of kernel modules; and
a kernel module signature verification system for verifying signature information of said plurality of kernel modules.

13. The computer operating system of claim 12, wherein said kernel signature information comprises kernel signature data for uniquely identifying each one of said plurality of kernel modules.

14. The computer operating system of claim 13, wherein said kernel signature information further comprises signature length data for further uniquely identifying each one of said plurality of kernel modules.

15. The computer operating system of claim 14, wherein said kernel signature information further comprises signature size data for each of said plurality of kernel modules.

16. The computer operating system of claim 15, wherein said kernel module signature verification system comprises a kernel cryptographic framework for authorizing and verifying signature information of kernel cryptographic modules loading into said kernel to provide kernel cryptographic services.

17. The computer operating system of claim 16, wherein said kernel module signature verification system further comprises a kernel cryptographic framework daemon.

18. The computer operating system of claim 17, wherein said kernel cryptographic framework daemon performs module verification of said plurality of kernel modules.

19. The computer operating system of claim 18, wherein said kernel cryptographic framework retrieves pathname information of said signature information for each of said plurality of kernel modules when said plurality of kernel modules attempt to load up to said kernel to perform cryptographic operations.

20. The computer operating system of claim 19, wherein said kernel cryptographic framework comprises a cryptographic service provider registration unit for registering each of said plurality of kernel modules wishing to provide cryptographic services in said kernel.

21. The computer operating system of claim 20, wherein said kernel cryptographic framework further comprises an intra-kernel communication unit for enabling communications between said kernel cryptographic framework and said kernel cryptographic framework daemon.

22. The computer operating system of claim 21, wherein said kernel cryptographic framework further comprises a data structure unit for storing said kernel module signature information.

23. The computer operating system of claim 22, wherein said kernel cryptographic framework and said kernel cryptographic framework daemon communicate via a plurality of input/output control commands.

24. The computer operating system of claim 23, wherein said input/output control commands comprise a door create command for creating a plurality of cryptographic doors for enabling communication between said kernel cryptographic framework and said kernel cryptographic framework daemon.

25. In a computer system, a computer software implemented kernel module signature verification system, comprising:
kernel cryptographic framework for verifying signatures uniquely defining each of a plurality of kernel cryptographic modules; and
kernel cryptographic framework daemon for performing module verification for each of said plurality of kernel cryptographic modules.

26. The kernel module signature verification system of claim 25, wherein said kernel cryptographic framework daemon retrieves pathname information of said signature information for each of said plurality of kernel modules when said plurality of kernel modules attempt to load up to said kernel to perform cryptographic operations.

27. The kernel module signature verification system of claim 26, wherein said kernel cryptographic framework comprises a cryptographic service provider registration unit for registering each of said plurality of kernel modules wishing to provide cryptographic services in said kernel.

28. The kernel module signature verification system of claim 27, wherein said kernel cryptographic framework further comprises an intra-kernel communication unit for enabling communications between said kernel cryptographic framework and said kernel cryptographic framework daemon.

29. The kernel module signature verification system of claim 28, wherein said kernel cryptographic framework further comprises a data structure unit for storing said kernel module signature information.

30. The kernel module signature verification system of claim 29, wherein said kernel cryptographic framework and said kernel cryptographic framework daemon communicate via a plurality of input/output control commands.

31. A method of verifying and authenticating kernel cryptographic modules, said method comprising:
providing a kernel cryptographic framework for verifying signature data in each of a plurality of kernel cryptographic modules; and
providing a kernel cryptographic framework for communicating with said kernel cryptographic framework for performing module verification of said plurality of kernel cryptographic modules.

32. The method of claim 31, wherein said kernel cryptographic framework daemon creates an unnamed door that is passed to establish communication between said kernel cryptographic framework and said kernel cryptographic framework daemon.

33. The method of claim 32, wherein said kernel cryptographic framework accepts registration requests from a requesting kernel module of said plurality of kernel cryptographic modules to register as cryptographic service providers.

34. The method of claim 33, wherein said kernel cryptographic framework daemon verifies signature data contained in each of said plurality of kernel cryptographic modules after said requesting kernel module has registered with said kernel cryptographic framework.

35. The method of claim 34, wherein said kernel cryptographic framework daemon passes results from verifying said signature data of said requesting kernel module to said kernel cryptographic framework.

36. The method of claim 35, wherein said kernel cryptographic framework verifies whether said results from verifying said signature data of said requesting kernel module compares with signature information stored in said kernel cryptographic framework to authenticate said requesting kernel module.
